(19) United States
(12) Patent Application Publication
(10) Pub. No.: US 2026/0284745 A1
(43) Pub. Date: Sep. 24, 2026

(54) ADDITIVELY MANUFACTURED PASSIVE COMPONENTS FOR HIGH FREQUENCY APPLICATIONS

(71) Applicant: UNIVERSITY OF PITTSBURGH - OF THE COMMONWEALTH SYSTEM OF HIGHER EDUCATION, PITTSBURGH, PA (US)

(72) Inventors: Paul R. Ohodnicki, Allison Park, PA (US); Bishal Bhandari, Pittsburgh, PA (US); Chuyuan Zheng, Walnut Creek, CA (US); Dipika Mandal, State College, PA (US); Suraj VENKATESHWARAN MULLURKARA, Pittsburgh, PA (US)

(73) Assignee: UNIVERSITY OF PITTSBURGH - OF THE COMMONWEALTH SYSTEM OF HIGHER EDUCATION, PITTSBURGH, PA (US)

(21) Appl. No.: 19/478,326

(22) PCT Filed: Jul. 24, 2024
(86) PCT No.: PCT/US2024/039307

§ 371 Date: Oct. 24, 2025

Related U.S. Application Data
(60) Provisional application No. 63/515,195, filed on Jul. 24, 2023.

(51) Int. Cl. B22F 10/14; B22F 10/12; B33Y 10/00; B33Y 40/20; H01F 3/08; H01F 41/02

(52) U.S. Cl. CPC B22F 10/14; B22F 10/12; B33Y 10/00; B33Y 40/20; H01F 41/0246; B22F 2201/03; B22F 2301/35; B22F 2302/25; B22F 2998/10; B22F 2999/00; H01F 3/08

(57) ABSTRACT

A method of manufacturing a passive component for electromagnetic applications, such as power electronics applications, electromagnetic shield applications, or other high frequency microwave applications, includes creating a component body from a soft magnetic material feedstock using an additive manufacturing technique and infiltrating the component body with an infiltrant to increase a bulk density of the component. Another method of manufacturing a passive component for electromagnetic applications, such as power electronics applications, electromagnetic shield applications, or other high frequency microwave applications, includes binder jet printing a component body from a soft magnetic material feedstock and sintering the component body. The material feedstock may have an engineered particle size distribution and/or may comprise various composite materials as described herein. In addition, the sintering may include liquid-assisted sintering.

### CROSS REFERENCE TO RELATED APPLICATIONS

This application claims priority to U.S. Provisional Patent Application Ser. No. 63/515,195, filed on Jul. 24, 2023 and titled “Additively Manufactured and Infiltrated Ferrite Based Passive Components for High Frequency Applications,” the disclosure of which is incorporated herein by reference.

### STATEMENT OF GOVERNMENT INTEREST

This invention was made with government support under grant #SRA0002476 awarded by the Defense Advanced Research Projects Agency (DARPA) and grant #N00014-21-1-2498 awarded by the Office of Naval Research (ONR). The government has certain rights in the invention.

### FIELD OF THE INVENTION

The disclosed concept relates to the manufacture of passive components in power electronics and microwave applications, such as ferrite based soft magnetic cores and other structures, and, in particular, to a method of manufacturing such passive components using additive manufacturing, such as binder jet printing, and, in certain embodiments, infiltration.

### BACKGROUND OF THE INVENTION

The recent emergence of switching devices based on wide-bandgap (WBG) semiconductor materials, such as SiC and GaN, have enabled the design of power electronics-based converters with an unprecedented combination of switching frequency, voltage level, and power handling capability. As power electronics engineers have learned to fully leverage the capabilities of new switching devices in the context of advanced converter designs, it has become increasingly clear that the passive components, and in particular, the magnetic components, will limit the ultimate performance in terms of efficiency, size, and weight. Further advances beyond WBG based power electronics converters are anticipated in the future as the semiconductor community increasingly looks towards next generation of Ultra-Wide Bandgap (UWBG) semiconductor materials, such as Ga₂O₃ and diamond.

Soft magnetic materials (SMM) are a class of ferromagnetic materials characterized by high permeabilities and low coercivities. These properties make them suitable for power magnetic applications such as transformers, motors and inductors, where the electromagnetic field is cycled repeatedly due to the application of an alternating current. Commonly used soft magnetic materials include Si steels, bulk crystalline alloys, amorphous alloys, nanocrystalline alloys and ferrites. Among these materials, manganese-zinc ferrites (MZF) are a prime choice of materials for power magnetic applications within the ~100 kHz to several MHz operating frequency range of relevance for emerging WBG and UWBG power electronics applications, primarily due to moderate saturation flux densities of 0.4-0.5 T and high resistivities, which limit eddy current losses. MZF based components, however, are currently manufactured using traditional powder processing techniques. This involves milling of individual powders (e.g., MnO, ZnO, and Fe2O3) followed by calcination. Thereafter, the powders are milled again with the addition of binders, pressed and sintered to obtain the final product in the desired shape. Such processing involves the use of tools and dies that require significant design time and cost, and the use of a compaction process, which becomes a major challenge as the size of components, such as cores increases, thereby requiring excessively large presses during component manufacturing. A change in component design thereby automatically imposes changes in the tool and die, making this manufacturing route unsuitable for rapid prototyping. It also limits the size and shape of commercially available components, such as cores, for inductor and transformer designers. Accordingly, successfully realizing the full potential of WBG or UWBG based power electronics using, for example, MZF based components, will require new classes of magnetic materials and manufacturing approaches.

### SUMMARY OF THE INVENTION

In one embodiment, the disclosed concept provides a method of manufacturing a passive component for electromagnetic applications that includes creating a magnetic component body, such as a toroidal magnetic core, from a soft magnetic material feedstock, such as an MZF feedstock, using an additive manufacturing technique, such as binder jet printing, and infiltrating the component body with an infiltrant to increase the bulk density of the component body and improve the magnetic properties of the component body.

In another embodiment, the disclosed concept provides a method of manufacturing a passive component for electromagnetic applications that includes binder jet printing a component body, such as a toroidal magnetic core, from a soft magnetic material feedstock comprising feedstock particles and thereafter sintering the component body to consolidate the component body and improve the magnetic properties of the component body.

### BRIEF DESCRIPTION OF THE DRAWINGS

A full understanding of the invention can be gained from the following description of the preferred embodiments when read in conjunction with the accompanying drawings in which:

FIG. 1 is a flowchart illustrating a method of manufacturing a passive electrical component using additive manufacturing according to an exemplary embodiment of the disclosed concept;

FIG. 2 is an image showing several exemplary binder jet printed cores manufactured according to an aspect of the disclosed concept;

FIG. 3 illustrates X-ray diffraction results showing phase pure ferrite spinels for exemplary sintered and oxide powder infiltrated, BMP infiltrated, and CI powder infiltrated samples according to the disclosed concept;

FIG. 4A shows the PSD of as-received (ARP) commercial spray-dried MZF granules and FIG. 4B shows a most frequent particle size distribution as a function of Equivalent Circle Diameter (ECDa) for an optimized powder feedstock according to one particular exemplary embodiment of the disclosed concept; and

FIGS. 6 and 7 are top level workflows showing various processing pathways of the component manufacturing method of the disclosed concept.

### DETAILED DESCRIPTION OF THE INVENTION

As used herein, the singular form of “a”, “an”, and “the” include plural references unless the context clearly dictates otherwise.

As used herein, the statement that two or more parts or components are “coupled” shall mean that the parts are joined or operate together either directly or indirectly, i.e., through one or more intermediate parts or components, so long as a link occurs.

As used herein, the term “number” shall mean one or an integer greater than one (i.e., a plurality).

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

The disclosed concept will now be described, for purposes of explanation, in connection with numerous specific exemplary details in order to provide a thorough understanding of the disclosed concept. It will be evident, however, that the disclosed concept can be practiced without these specific details without departing from the spirit and scope of disclosed concept.

For emerging power electronics based upon WBG and UWBG devices, soft ferrite ceramics, such as Mn—Zn and Ni—Zn, are primary candidates for high kHZ to MHz and even GHz ranges, as the refractory nature of such materials provides high resistivity, which minimizes loss. However, traditional ceramic processing requires ferrite powders to be compacted in a fixed die and later sintered, drastically limiting manufacturing scalability and capability for spatially engineering magnetic cores with optimal performance. Mn—Zn and Ni—Zn ferrites are also of interest for microwave applications, such as electromagnetic interference (EMI) shielding and other high frequency microwave communication applications. While the scalability is not necessarily a primary concern in such cases, the ability to tune the microstructure and porosity can potentially enable a wide range of microwave performance through tailoring of the dielectric constant and/or permeability. Engineered porosity can also introduce multiple scattering events in a microwave absorber/shielding material, thereby enhancing shielding effectiveness.

Recently, the rapid development of binder jet 3D printing (BJ3DP) opens possibilities for novel powder processing where green bodies are made without the constraints of a die set. BJ3DP also provides unique advantages, including accelerated production rate, shape design flexibility, and spatially tuned materials. More specifically, it is generally regarded that the sinterability of soft ferrite ceramic powder compacts, made by printing materials such as spray-dried (SD) powders and fully reacted (FR) powders, depends on the homogeneity of the printed green microstructures. The remanent porosity of sintered BJ3DP materials can also be impacted by printing defects and printing parameter optimization. In particular, in BJ3DP, powders are spread layer-by-layer with a compaction force that is negligible as compared to traditional die-pressing, creating large interlayer region voids. Additionally, SD powder granules are intrinsically porous, with green density estimated to be <30% in many cases. Porous SD granules also introduce heterogencity and wide particle size distributions (PSDs), making green microstructures that are highly porous using standard processing techniques.

Moreover, ferrites with their synergistic magnetic and electrical properties are well-known to be highly promising electromagnetic wave absorbing/shielding (EMA) components. Nowadays, EMA are necessary not only to cut down the EM wave pollution from the environment, but also to shield EM waves to prevent information theft, which is becoming essential in in the defence and military fields. Proper tuning of ferrite properties such as permeability (u) and permittivity (c) can lead to broader bandwidth (BW) and induce better impedance matching (i.e., |Zᵢₙ/Z₀| ~ 1), thus ensuring higher reflection loss (RL=20 log|(Zᵢₙ−Z₀)/(Zᵢₙ+Z₀)|). Further, a high value of ε and μ is desirable to enhance the wave attenuation and lessen the thickness (t) of the absorbing material. Successful impedance matching from MHz to GHz range in these ferrites (preferably NZF) also leads to its application in other communication devices, such as in 5G antenna, commercial radar, Bluetooth etc. Apart from dielectric and magnetic losses, total loss can be augmented by inducing mm-length porous channels and additional interfaces to the bulk ferrite, which elongates path-length of the microwave through internal reflection and enhances total loss in the material. In this context, additive manufacturing via binder jet printing can be of great benefit. The porosity/density of the printed cores can be engineered by controlling the printing parameters and quality of the feedstock material. With controlled porosity in the samples, its material properties and mechanical strength can be kept intact and such materials can also be suitable for high temperature and high-power microwave shielding applications.

As described herein, the disclosed concept addresses the low final density of cores and other components made via additive manufacturing printing techniques, such as BJ3DP or digital light processing (DLP), through a two-fold approach, including improving the quality of as-printed components, and developing novel consolidation processes post-printing. BJ3DP or DLP application to passive components, such as cores, made from soft magnetic ferrite other powder-based soft magnetic material feedstock, represents a major potential advance in scalable, flexible, component manufacturing. Because BJ3DP and DLP produce components with remanent porosity, the manufacturing pathway also opens the door for potential additional manufacturing pathways targeted to: (1) increase or tailor the density and engineer the porosity, and (2) increase functionality through techniques that create “multi-material” components and ferrite structures by leveraging remanent porosity. Moreover, the disclosed concept provides for the improved manufacture of components, such as magnetic cores, by using one or more of the following: (1) the tuning of the powder feedstock for the additive manufacturing process, (2) the optimization of the additive manufacturing, e.g., printing parameters, (3) the optimization of the sintering parameters, if sintering is to be employed, and (4) novel and improved infiltration/consolidation techniques. Post-processing methods can potentially further tailor the pore size and distribution, and also enable composite material systems with engineered functional properties for targeted applications. In addition, DLP is one of the very few manufacturing technologies that can produce fully enclosed hollow structures due to its unique nature of processing, so it holds the potential of manufacturing highly geometrically optimized/customized structures.

With respect to the tuning of the powder feedstock, one example is that, in the case of as received ferrite powders, such as Mn—Zn ferrite powders received from a powder supplier or following custom powder synthesis, sieving can be utilized to optimize the PSD to provide a PSD-tailored powder. More specifically, a PSD-tailored powder can be designed to exhibit a desired distribution of particle sizes. For example, a PSD-tailored powder can have a maximum particle size below a specified limit as measured by the equivalent circular diameter. As another example, a PSD-tailored powder can have a desired distribution of particle sizes, such as a bi-modal distribution or an even more complex distribution. In other cases, a PSD-tailored powder can have a maximum and minimum particle size. A PSD-tailored powder can also improve the powder bed packing efficiency and reduce the layer thickness, thereby increasing dimensional accuracy. For example, where BJ3DP is used, the maximum particle size can be constrained so as to not exceed the printer layer thickness. Alternatively, the maximum particle size can be limited to be below ½ the printer layer thickness. For a typical resolution of 100 μm for BJ3DP materials, a PSD with particle sizes dominated by particles in the range of 100 μm or less, even as low as 50 μm or less, may be preferred to ensure sufficient powder packing.

With respect to the optimization of the printing parameters, parameters such as roller speed, drying time, and saturation level, among others, may be tuned to improve powder bed packing and suppress heterogeneity from printing defects. With large particle granulates, such as in as-received, spray-dried Mn—Zn ferrite powders, hopper oscillation speed may be increased to ensure that sufficient powder is deposited onto the print bed. The binder saturation level must also be adjusted accordingly to guarantee enough binder infiltration depth while being jetted onto the powder bed surface. Drying power output, temperature and time may further be correlated with the binder saturation level to prevent binder bleeding or smearing of the jetted surface. In one particular exemplary binder jet printing embodiment, the printing parameters include one or more of the following in combination: binder saturation of 70, drying time of 70 s, layer thickness of 150 μm, roller rotating speed of 200 rpm, roller travelling speed of 5 mm/s, recoating speed of 20 mm/s, and oscillator speed of 3300-3500.

With respect to the optimization of sintering conditions, the sintering temperatures and times may be optimized to achieve maximum densification of the microstructure or to tailor the porosity and grain size for a specific desired value relevant for the application. Sintering temperature and time may also be optimized based on as-printed green microstructures and powder packing efficiencies, while preventing excessive grain coarsening, differential sintering, or phase decomposition. A combination of simple isothermal sintering may be applied, such as a two-step sintering process to activate densification kinetics more efficiently while avoiding undesired microstructural evolution.

With respect to improved infiltration/consolidation techniques, in certain embodiments infiltration will be pursued as an additional or alternative consolidation process, which can be substituted for or complementary to traditional sintering methods. The following infiltration approaches will, according to the disclosed concept, improve the manufacturing process if a primary objective is to achieve a maximum density or to tailor the density for a specific application. In a first infiltration approach, primary ferrite particles of the base ferrite manufactured using BJ3DP (the same powder feedstock) that are dispersed in a low surface energy liquid will infiltrate the open porosity of printed samples such that materials will be deposited in pore channels. Alternative oxide powder feedstocks, such as the original raw powders of individual constituent oxides (e.g. MnO, ZnO, and FexOy for MnZn-ferrite), can also be utilized in these embodiments. In some cases, PSD-optimized powder feedstocks are also utilized for infiltration. For example, the PSD-optimized powder may have an average particle size similar to or even substantially smaller than the average pore diameter to ensure efficient infiltration. Infiltrated material may also undergo heat treatment to induce sintering and consolidation, with the expectation of homogenized green microstructures reducing the extent of differential sintering and yielding higher final densities. In a second infiltration approach, raw metal (e.g., Fe, Mn, Ni, Zn) powders dispersed in a liquid solvent will be infiltrated and heat-treated under controlled atmosphere. In some cases, the raw metals may involve core-shell particles or particles with passivated surfaces such as carbonyl iron or Ni-oxide passivated Ni particles. The metals will oxidize, react, and form a homogeneous spinel phase. Since metal oxides have larger specific volumes, they will dilate and occupy the pore spaces. In other cases, the infiltrant may comprise a polymer or an oxide or dielectric dispersed in a liquid solvent. In addition to these methods, liquid-assisted sintering techniques can be integrated to further enhance the consolidation process. Liquid-assisted sintering involves the introduction of a liquid phase during sintering, which can promote particle rearrangement, mass transport, and pore filling, thereby enhancing densification. For example, a small amount of a liquid-forming additive, such as a low-melting oxides such as Bi₂O₃, V₂O₅, MoO₃, B₂O₃, GeO₂, Nb₂O₅, and Cu₂O, etc., can be introduced into the powder mixture or through the infiltration method discussed above. During sintering, these additives melt and form a liquid phase that facilitates the rearrangement and densification of solid particles, resulting in higher densities and improved microstructures.

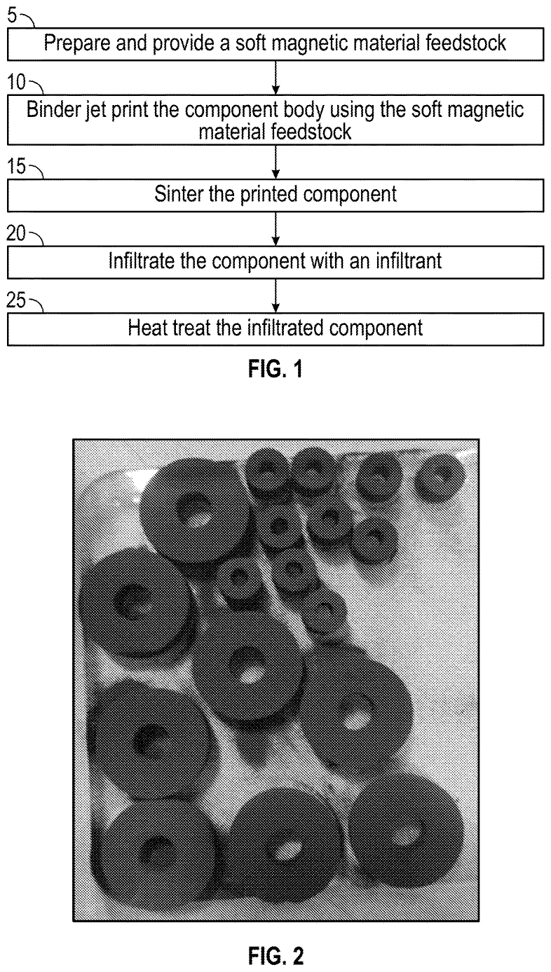

FIG. 1 is a flowchart illustrating a method of manufacturing a passive electrical component, such as, without limitation, a toroidal magnetic core or an electromagnetic interference shield or absorber, using additive manufacturing according to an exemplary embodiment of the disclosed concept. The passive components manufactured using the method of the disclosed concept are particularly suitable for power magnetic applications, such as, without limitation, transformers, motors, inductors, choke coils, phase shifters, and noise filters, where field is cycled repeatedly due to the application of an alternating current.

Referring to FIG. 1, the method begins at step 5, wherein a soft magnetic material feedstock is prepared and provided. In the non-limiting exemplary embodiment, the soft magnetic material feedstock is a ceramic magnetic powder material. In one particular implementation, the ceramic magnetic powder material is a ferrite material, such as, without limitation, a manganese-zinc (Mn—Zn) ferrite (including Mn—Zn particles), a nickel-zinc (Ni—Zn) ferrite (including Ni—Zn particles), Co-containing Mn—Zn and Ni—Zn ferrites, and a hexaferrite such as Ba-hexaferrite. Additional ferrites include Ni-ferrite, Co-ferrite, Mn-ferrite, multicomponent ferrites such as NiCoMnZn-ferrites, and various other combinations. Additional oxides and magnetic oxides (for use as the fedstick) include a garnet such as yttrium iron garnet (YIG) and a perovskite such as lanthanum strontium iron (cobalt) oxide. In addition, the ferrite or magnetic oxide material may be a spray-dried (SD) powder or fully reacted (FR) powder. FR powders are fabricated based on SD powders, where the powder particles undergo extra pre-sintering such that raw metal oxides in the SD powder react and form a single-phase spinel of coarsened grains in the powder feedstock. Moreover, in certain particular embodiments, step 5 may include optimizing the soft magnetic material feedstock so as enhance the density and/or magnetic properties of the manufactured passive components. Particular ways in which such optimization may be accomplished are described in more detail elsewhere herein.

The method then proceeds to step 10, wherein the passive electrical component is binder jet 3D printed using a suitable binder jet printing machine. One of the unique features of binder jet printing is the porous nature of as-printed green bodies. Binder jetting usually includes the following steps: powder spreading (recoating), printhead nozzle jetting, and drying/partial curing of the binder. During both powder spreading and nozzle jetting, systematic defects will be introduced, including inter-layer defects along the X-Y plane resulting from lowered packing efficiency at the layer interfaces, and printing lines along Z-direction, which are introduced by interactions between binder droplets and the surface of the powder bed. These anisotropic defects are highly periodic and can be tuned by varying certain printing parameters and the powder feedstock. Therefore, binder jetting of components according to the disclosed concept opens up the possibility to manufacture customizable magnetic composite materials as described herein. FIG. 2 is an image showing several exemplary binder jet printed cores manufactured according to an aspect of the disclosed concept. In these exemplary cores, the maximum particle size of the feedstock was 106 μm.

Next, at step 15, the as-printed component is sintered under controlled atmosphere. In the exemplary embodiment, the as-printed component is pressure-less sintered at different temperatures between 1300° C. and 1400° C., which results in an optimized single-phase spinel at 1350° C. In one particular, non-limiting exemplary embodiment, the sintering temperatures may be set at 1300° C., 1330° C., 1350° C., 1380° C. and 1400° C., and for each temperature the isothermal sintering time may be held constant at 5 h, followed by controlled cooling to room temperature. Temperature profiles for isothermal sintering were as follows: room temperature to 200° C. at 5° C./min then hold for 20 min; 200-600° C. at 4.7° C./min then hold for 20 min; 600—designated sintering temperature at 4° C./min; isothermal hold for 5 h; then cool down to room temperature at 4° C./min. Also, it has been demonstrated that oxygen partial pressure plays an important role in controlling the phase purity of Mn—Zn ferrites at elevated temperatures. Therefore, in one embodiment, an air-nitrogen gas distribution system may be used and may be programmed such that partial pressure of oxygen (PO₂) is held below the critical value for phase decomposition as a function of temperature upon cooling. PO₂ as a function of temperature T may be controlled by adjusting the mix ratio of oxygen and nitrogen according to the following equation:

$$log ( {P}_{{O}_{2}} ) = log ( 0.004 ) \frac{14540}{T}$$

Moreover, it has been found that following the sintering step, the sintered component will have relatively high porosity (e.g., a final density of below 55%) and may have less than advantages magnetic properties, such as low magnetic permeability. Thus, following step 15, the method proceeds to step 20, wherein the component is infiltrated with an infiltrant to consolidate/densify the component and improve the magnetic performance thereof. The aim of the infiltration process is to increase density by completely or partially filling open and interconnected pores with micron and submicron-sized infiltrant powder, thereby increasing mass density. This leads to a reduction in the distance between granules that will enhance sintering activity by promoting increased necking between granules.

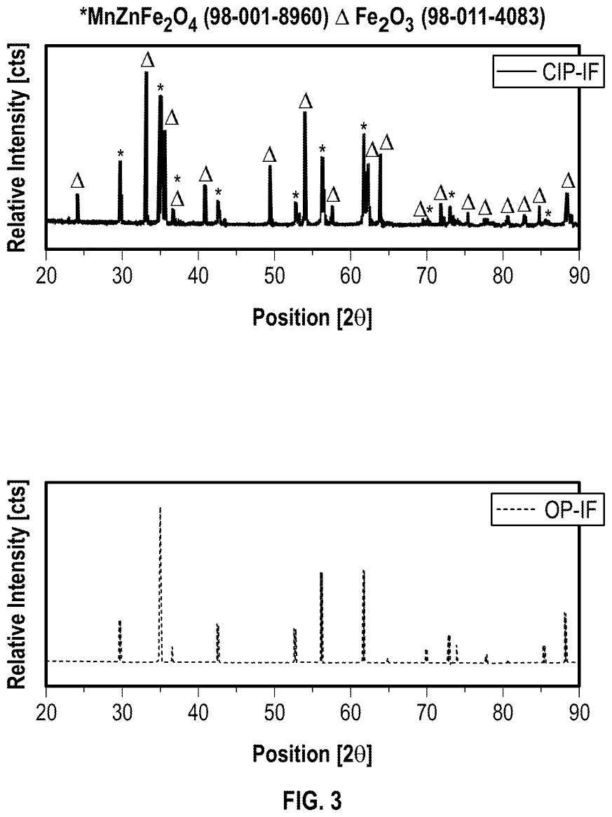

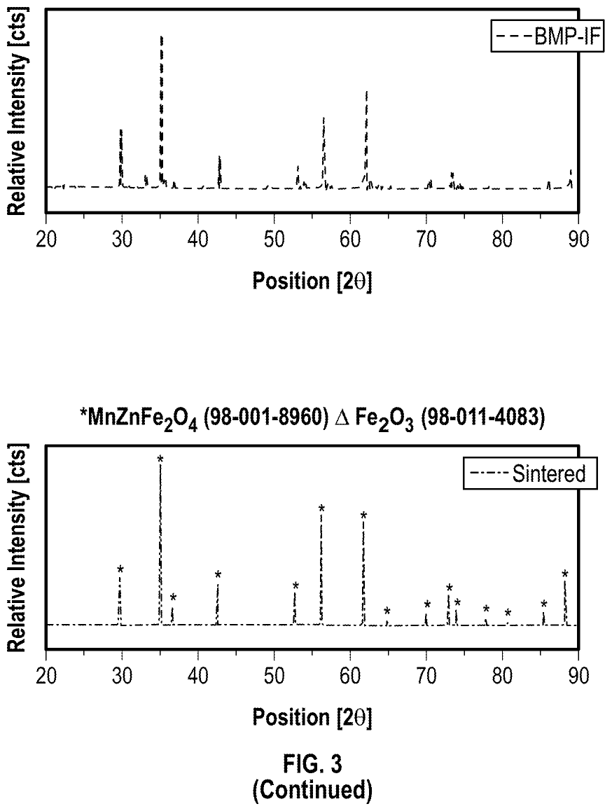

In various exemplary embodiments, the infiltration process and the infiltrant can take on a number of different forms. In one non-limiting exemplary embodiment, vacuum and/or pressure infiltration with concentrated slurries is used to enhance the relative bulk density post-sintering. With respect to vacuum infiltration, one important thing to consider is that the vacuum level should not exceed the boiling point of the solvent used in the infiltrant dispersion. If it does, solvent evaporation can occur, changing slurry viscosity, which may result in non-uniformity. In addition, in another non-limiting exemplary embodiment, the infiltrant is a dispersion of the ferrite particles of the feedstock, such as Mn—Zn or Ni—Zn particles, in a liquid solvent, such as alcohol (e.g., ethanol) or ethylene glycol (1:1 ratio). In another non-limiting exemplary embodiment, the infiltrant is a dispersion of raw metal powder, such as, without limitation, raw Fe powder, raw Ni powder, raw Mn powder, raw Zn powder, core-shell particles (i.e., a core material, typically a metal or metal oxide, surrounded by a shell material such as a polymer, silica, or another metal or metal oxide), or particles with passivated surfaces such as carbonyl Fe or Ni-oxide passivated Ni particles, in a liquid, such as alcohol (e.g., ethanol) or ethylene glycol (1:1 ratio). In still another non-limiting exemplary embodiment, the infiltrant is a dispersion of an oxide, such as MnO, ZnO, and FexOy, in a liquid, such as alcohol (e.g., ethanol) or ethylene glycol (1:1 ratio). In yet further alternative embodiments, the infiltrant may be any of the following materials dispersed in a liquid, such as alcohol (e.g., ethanol) or ethylene glycol (1:1 ratio): (i) a mixture of a constituent oxide of MnZn ferrite powders (OP −325 mesh powder: Mn3O4 (Alfa Aesar, 97%), ZnO (Alfa Aesar, 99%) and Fe2O3 (99.9% purity)), (ii) a carbonyl iron powder (CI) (98% purity, spherical 1-3 <5 μm), or (iii) black milled MnZn ferrite powder (BMP, irregular and <5 μm). Given the sensitivity of magnetic properties to cations and their distribution within the sample matrix, these particular infiltrant materials may preserve/enhance magnetic characteristics. Specifically, CI powder is hypothesized to promote the densification process due to a decrease in specific volume because of the conversion of metallic iron into iron oxide, which further encounters solid state reaction process that enhance the density. BMP is hypothesized to increase the density by increasing the particle contact points and solid-state reaction, whereas oxide powder would increase density due to solid state reaction only. FIG. 3 illustrates X-ray diffraction results showing phase pure ferrite spinels for exemplary sintered and oxide powder infiltrated, BMP infiltrated, and CI powder infiltrated samples according to the disclosed concept.

In another particular exemplary embodiment, the infiltration step can be sued to make composite components by mixing multiple materials that have different properties. For example, the infiltrant can be one material that has different electromagnetic properties than the feedstock, with the intent of making a composite that has unique properties as compared to any single-phase material. One good example of this is for EMI applications, where materials with complementary permittivity and permeability values may be mixed to maximize the EMI (shielding) performance. Another good example of this is for power electronics applications, where materials with different phases with different saturation magnetization values and losses may be mixed to balance the flux density and losses to improve these properties relative to the individual materials. One specific example includes MnZn-ferrite/NiZn-ferrite composites, where NiZn-ferrite is the feedstock used in printing and MnZn-ferrite is the infiltrant. In this example, MnZn-ferrite has higher flux density while NiZn-ferrite has lower losses at high frequency. Another specific example includes dielectric/NIZn-ferrite composites, where NiZn-ferrite is the feedstock used in printing and a dielectric material that is not ferro- or ferrimagnetic is the infiltrant in order to tune the effective permeability and permittivity for EMI. Still another specific example includes highly porous/NiZn-ferrite composites where NiZn-ferrite is the feedstock used in printing and the infiltrant has an engineered highly porous porosity. Yet another specific example includes a metal/ferrite composites, where a ferrite, such as NiZn-ferrite, is the feedstock used in printing and a metal, such as carbonyl iron, is the infiltrant in order to trading off between the differences in density and magnetic permeability of the two materials.

Finally, following step 20, the method proceeds to step 25, wherein the infiltrated component is heat treated for a period of time for further consolidation. In the exemplary embodiment, the infiltrated component is heat treated at 1350° C. for 5 hours. Prior to the heat treatment, the infiltrated component may be transferred to a pressure chamber where positive air pressure of a certain level (e.g., 45 psi) is used to force the infiltrant particles into the pores of the component.

As noted above, in various embodiments, step 5 may include optimizing the feedstock before the binder jet printing. In particular, in one example, the optimization includes sieving the original feedstock to cause it to have a controlled, predetermined particle size distribution (PSD), such as a PSD having a predetermined maximum particle size (e.g., 100 microns) and a predetermined minimum particle size (10 microns). In still another example, the controlled, predetermined PSD is bi-modal. A bi-modal PSD, which features two distinct particle size ranges, can enhance the packing density and uniformity of the print bed layer. Consequently, this results in a more efficient binder jet printing process which is critical for efficient sintering. Fine particles fill the interstices between larger particles, leading to a higher green density, which reduces shrinkage and distortion during sintering. Moreover, the presence of larger particles provides structural stability, minimizing the risk of deformation. As a result, a bi-modal PSD improves the densification, ensuring better dimensional accuracy and reduced porosity. In other embodiments, the sieving causes the feedstock to have a PSD having a maximum particle size that is less than or equal to a specified limit as measured by an equivalent circular diameter. For example, the binder jet printing of step 10 may have a printer layer thickness, and the specified limit for the particles after sieving is equal to the printer layer thickness, or, alternatively, one-half of the printer layer thickness.

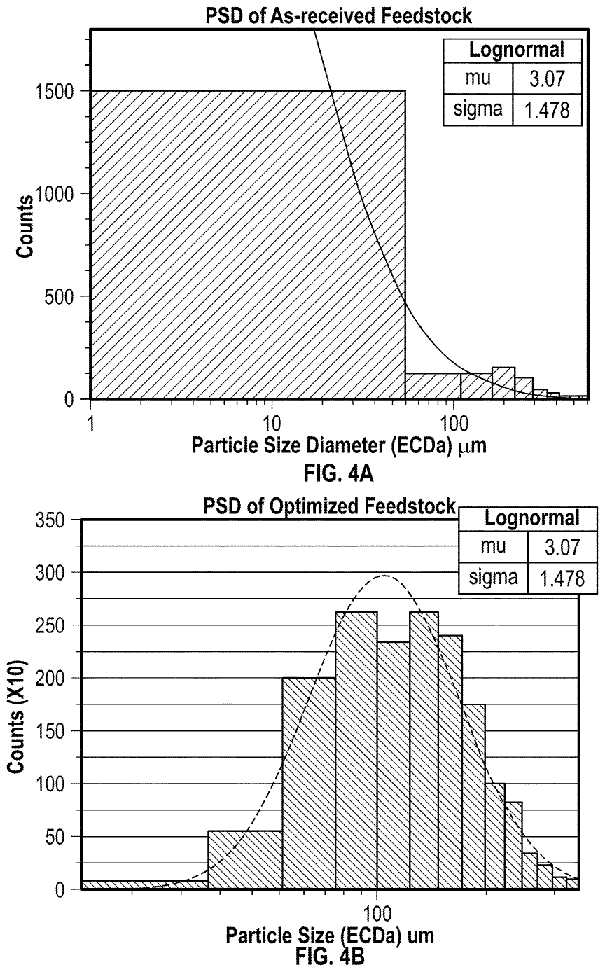

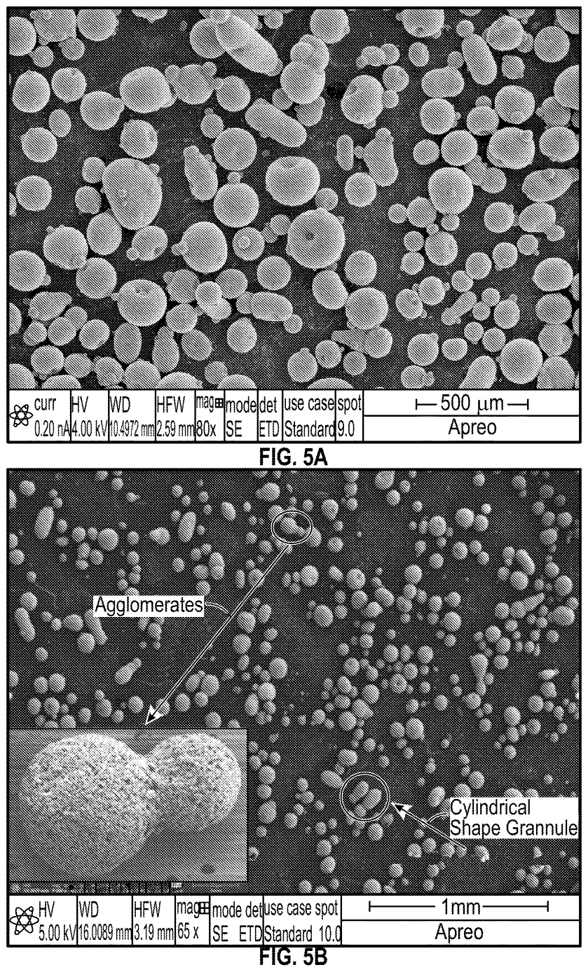

FIG. 4A shows the PSD of as-received (ARP) commercial spray-dried MZF granules and FIG. 4B shows a most frequent particle size distribution as a function of Equivalent Circle Diameter (ECDa) for an optimized powder feedstock according to one particular exemplary embodiment of the disclosed concept. In addition, FIG. 5A is an SEM micrograph of commercial MZF granules and FIG. 5B is an SEM micrograph Optimized MZF granules after sieving.

Furthermore, in the exemplary embodiments described thus far, the additive manufacturing technique that is used is 3D binder jet printing. In other embodiments, alternative additive manufacturing techniques, such as DLP 3D printing, may also be used. In DLP 3D printing, a projector and a DMD (digital mirror device) is used to selectively cure a feedstock, such as a photocurable slurry containing ferrite powders, one layer at a time.

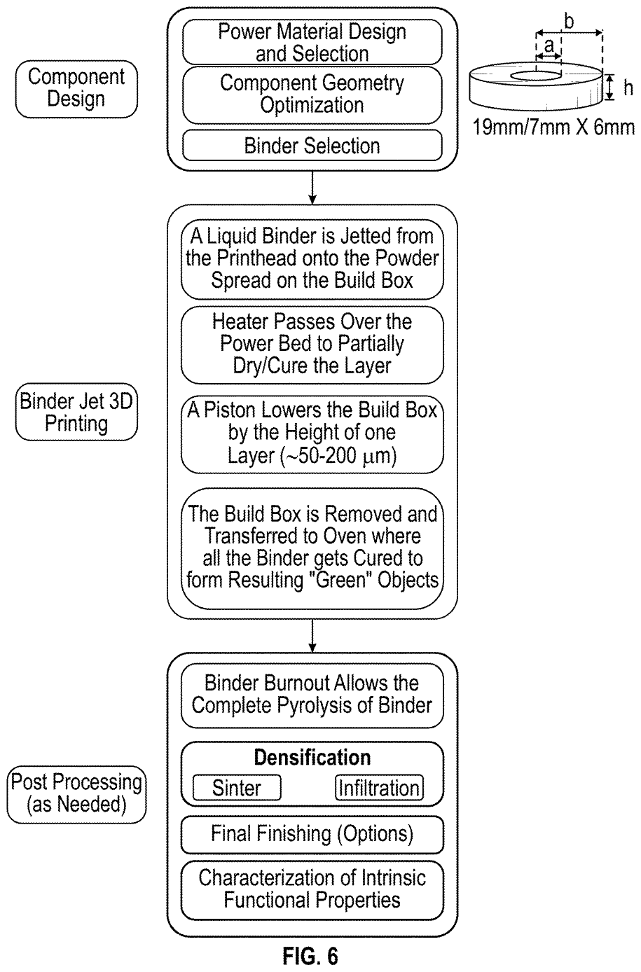

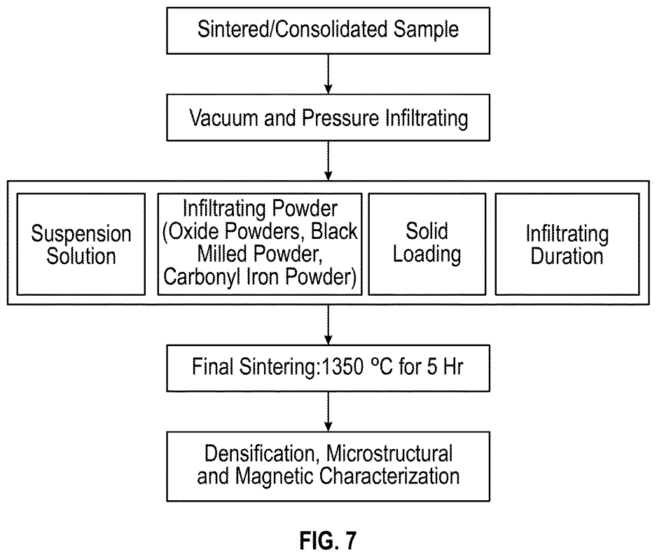

The disclosed concept thus provides novel methods of manufacturing passive components for use in power electronics and microwave applications using additive manufacturing, such as binder jet printing, and certain post processing steps, such as infiltration. Top level workflows of such novel manufacturing techniques, including various processing pathways, are provided in FIGS. 6 and 7. As described herein and as shown in FIGS. 6 and 7, the disclosed concept therefore provides a significant advance in scalable and flexible component manufacturing in, for example, power electronics and microwave applications.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A method of manufacturing a passive component for electromagnetic applications, comprising:
creating a component body from a soft magnetic material feedstock comprising feedstock particles using an additive manufacturing technique; and
infiltrating the component body with an infiltrant to increase a bulk density of the component body.

2. The method according to claim 1, wherein the soft magnetic material feedstock comprises a ceramic material.

3. The method according to claim 2, wherein the ceramic material comprises a ferrite material.

4. The method according to claim 3, wherein the ferrite material is a MnZn ferrite material.

5. The method according to claim 3, wherein the ferrite material is a NiZn ferrite material.

6. The method according to claim 1, wherein the soft magnetic material feedstock comprises an SD powder.

7. The method according to claim 1, wherein the soft magnetic material feedstock comprises an FR powder.

8. The method according to claim 1, further comprising heat treating the component body after the infiltrating to induce consolidation.

9. The method according to claim 1, further comprising pressure-less sintering the component body before infiltrating the component body.

10. The method according to claim 9, wherein the pressure-less sintering is performed at a temperature between 1300° C. and 1400° C.

11. The method according to claim 9, further comprising subjecting the component body to positive air pressure before the pressure-less sintering.

12. The method according to claim 1, wherein the infiltrant is an infiltrant dispersion comprising infiltrant particles in a liquid.

13. The method according to claim 12, wherein the liquid comprises alcohol.

14. The method according to claim 13, wherein the liquid comprises ethanol.

15. The method according to claim 13, wherein the liquid comprises ethylene glycol.

16. The method according to claim 1, wherein the infiltrant comprises a dispersion of the feedstock particles in a liquid solvent.

17. The method according to claim 16, wherein the feedstock particles are Mn—Zn particles or Ni—Zn particles.

18. The method according to claim 1, wherein the infiltrant comprises a dispersion of a raw metal powder in a liquid solvent.

19. The method according to claim 18, wherein the raw metal powder is one or more of a raw Fe powder, a raw Ni powder, a raw Mn powder, a raw Zn powder, core-shell particles, carbonyl Fe particles, or Ni-oxide passivated Ni particles.

20. The method according to claim 1, wherein the infiltrant comprises a dispersion of a polymer in a liquid solvent.

21. The method according to claim 1, wherein the infiltrant comprises a dispersion of an oxide or dielectric in a liquid solvent.

22. The method according to claim 21, wherein the soft magnetic material feedstock is an Mn—Zn ferrite material and wherein the oxide is MnO, ZnO, or FexOy.

23. The method according to claim 1, further comprising sieving an initial powder feedstock to form the soft magnetic material feedstock.

24. The method according to claim 23, wherein the sieving causes the soft magnetic material feedstock to have a PSD with a plurality of particle sizes ranging between approximately 10 microns and 100 microns.

25. The method according to claim 23, wherein the sieving causes the soft magnetic material feedstock to have a PSD having a maximum particle size less than or equal to a specified limit as measured by an equivalent circular diameter.

26. The method according to claim 23, wherein the additive manufacturing technique has a printer layer thickness, and wherein the specified limit is the printer layer thickness.

27. The method according to claim 23, wherein the additive manufacturing technique has a printer layer thickness, and wherein the specified limit is one-half of the printer layer thickness.

28. The method according to claim 23, wherein the sieving causes the soft magnetic material feedstock to have a predetermined PSD.

29. The method according to claim 28, wherein the predetermined PSD is bi-modal including two distinct particle size ranges.

30. The method according to claim 23, wherein the sieving causes the soft magnetic material feedstock to have a PSD having a predetermined maximum particle size and a predetermined minimum particle size.

31. The method according to claim 23, wherein the infiltrant has an average particle size that is smaller than an average pore diameter of the component body to ensure efficient infiltration.

32. The method according to claim 1, wherein additive manufacturing technique is binder jet printing.

33. The method according to claim 1, wherein additive manufacturing technique is digital light process (DLP) 3D printing and wherein the soft magnetic material feedstock comprises a photocurable slurry containing a ferrite powder.

34. The method according to claim 1, wherein the passive component is a soft magnetic core.

35. The method according to claim 34, wherein the soft magnetic core has a toroidal shape.

36. The method according to claim 1, wherein the passive component is an electromagnetic interference shield and/or absorber.

37. The method according to claim 1, wherein the passive component is utilized for microwave communications.

38. The method according to claim 1, wherein the infiltrating is tailored to produce a desired permeability and permittivity in the passive component for EMI applications.

39. The method according to claim 9, wherein the sintering includes holding a partial pressure of oxygen held below a critical value for phase decomposition as a function of temperature upon cooling.

40. The method according to claim 12, wherein the infiltrating comprises vacuum infiltration wherein a vacuum level does not exceed a boiling point of the liquid used in the infiltrant dispersion.

41. The method according to claim 1, further comprising liquid-assisted sintering the component body before or after infiltrating the component body.

42. The method according to claim 41, wherein the liquid-assisted sintering comprises adding a liquid-forming additive into the soft magnetic material feedstock.

43. The method according to claim 42, wherein the liquid-forming additive comprises an oxide.

44. The method according to claim 43, wherein the oxide comprises Bi₂O₃, V₂O₅, MoO₃, B₂O₃, GeO₂, Nb₂O₅, and Cu₂O.

45. The method according to claim 41, wherein the liquid-assisted sintering comprises adding a liquid-forming additive into the infiltrant.

46. The method according to claim 45, wherein the liquid-forming additive comprises an oxide.

47. The method according to claim 46, wherein the oxide comprises Bi₂O₃, V₂O₅, MoO₃, B₂O₃, GeO₂, Nb₂O₅, and Cu₂O.

48. The method according to claim 1, wherein the soft magnetic material feedstock and the infiltrant have differing electromagnetic properties.

49. The method according to claim 48, wherein the soft magnetic material feedstock and the infiltrant have different and complementary permittivity and permeability values.

50. The method according to claim 48, wherein the soft magnetic material feedstock and the infiltrant have different phases with different saturation magnetization values and magnetization losses.

51. The method according to claim 1, wherein the soft magnetic material feedstock is NiZn-ferrite and the infiltrant is MnZn-ferrite.

52. The method according to claim 1, wherein the soft magnetic material feedstock is NiZn-ferrite and the infiltrant is a dielectric material that is not ferro- or ferrimagnetic.

53. The method according to claim 1, wherein the soft magnetic material feedstock is a ferrite and the infiltrant is a metal.

54. The method according to claim 53, wherein the ferrite is NiZn-ferrite and the metal carbonyl iron.

55.-75. (canceled)
